(19) United States
(12) Patent Application Publication
(10) Pub. No.: US 2025/0306251 A1
(43) Pub. Date: Oct. 2, 2025

(54) Tunable Lens with Lens Surface Measurements

(71) Applicant: Apple Inc., Cupertino, CA (US)

(72) Inventors: James E Pedder, Oxon (GB); Matthew D Hollands, Cambridge (GB); Thomas M Gregory, Cambridge (GB)

(21) Appl. No.: 19/032,654

(22) Filed: Jan. 21, 2025

Related U.S. Application Data
(60) Provisional application No. 63/573,399, filed on Apr. 2, 2024.

(51) Int. Cl. G02B 3/14

(52) U.S. Cl. CPC G02B 3/14

(57) ABSTRACT

An electronic device may include a lens module with a tunable lens. To determine an optical power associated with the lens module, components within the electronic device may measure the real time position and/or curvature of an adjustable surface of the tunable lens. The head-mounted device may include a camera formed separately from a display that measures a pattern of glints, may include photodiodes integrated into a display that measures the pattern of glints, may include a camera formed separately from a display that measures stray light from the lens module, may include a plurality of peripheral position sensors distributed around a perimeter of the adjustable surface of the tunable lens, and/or may include capacitive electrode layers for capacitive sensing.

This application claims the benefit of U.S. provisional patent application No. 63/573,399, filed Apr. 2, 2024, which is hereby incorporated by reference herein in its entirety.

### BACKGROUND

This relates generally to electronic devices and, more particularly, to wearable electronic device systems.

Electronic devices are sometimes configured to be worn by users. For example, head-mounted devices are provided with head-mounted structures that allow the devices to be worn on users' heads. The head-mounted devices may include optical systems with lenses.

Head-mounted devices typically include lenses with fixed shapes and properties. If care is not taken, it may be difficult to adjust these types of lenses to optimally present content to each user of the head-mounted device.

An electronic device may include a tunable lens, at least one infrared light source configured to direct infrared light towards the tunable lens to generate a pattern of glints on an adjustable surface of the tunable lens, an image sensor configured to capture an image of the pattern of glints, and control circuitry configured to determine an optical power of the tunable lens based on the image of the pattern of glints.

An electronic device may include a tunable lens having a lens element with adjustable curvature, position sensors distributed around a periphery of the lens element, wherein each position sensor is configured to sense a position of a respective point of the periphery of the lens element, and control circuitry configured to determine an optical power of the tunable lens based on the positions sensed by the position sensors.

An electronic device may include a tunable lens having a fluid-filled chamber defined by first and second lens elements, a first capacitive electrode layer that is formed on the first side of the fluid-filled chamber, a second capacitive electrode layer that is formed on the second side of the fluid-filled chamber, and control circuitry configured to determine an optical power of the tunable lens based on a sensed capacitance between the first and second capacitive electrode layers. The fluid-filled chamber and an air gap may be interposed between the first and second capacitive electrode layers.

An electronic device may include a lens module comprising a plurality of lens elements, a display configured to emit light towards the lens module, an image sensor configured to capture reflections of the light off multiple surfaces within the lens module, and control circuitry configured to determine an optical power of the tunable lens based on the captured reflections of the light off the multiple surfaces within the lens module.

### BRIEF DESCRIPTION OF THE DRAWINGS

FIG. 1 is a schematic diagram of an illustrative electronic device in accordance with some embodiments.

FIG. 2 is a top view of an illustrative head-mounted device with a lens module in accordance with some embodiments.

FIG. 3 is a side view of an illustrative lens module in accordance with some embodiments.

FIGS. 4 and 5 are side views of an illustrative tunable lens in different tuning states in accordance with some embodiments.

FIG. 6 is a side view of an illustrative head-mounted device with an image sensor for determining the optical power of a tunable lens in accordance with some embodiments.

FIGS. 7A-7C are top views of illustrative glint patterns that may be detected on an adjustable surface of the tunable lens in accordance with some embodiments.

FIG. 8 is a side view of an illustrative head-mounted device with a display that has integral photodiodes for determining the optical power of a tunable lens in accordance with some embodiments.

FIG. 9A is a side view of an illustrative head-mounted device with position sensors for determining the optical power of a tunable lens in accordance with some embodiments.

FIG. 9B is a top view of an illustrative tunable lens with position sensors distributed around the periphery of the tunable lens in accordance with some embodiments.

FIG. 10 is a side view of an illustrative head-mounted device with capacitive sensing for determining the optical power of a tunable lens in accordance with some embodiments.

### DETAILED DESCRIPTION

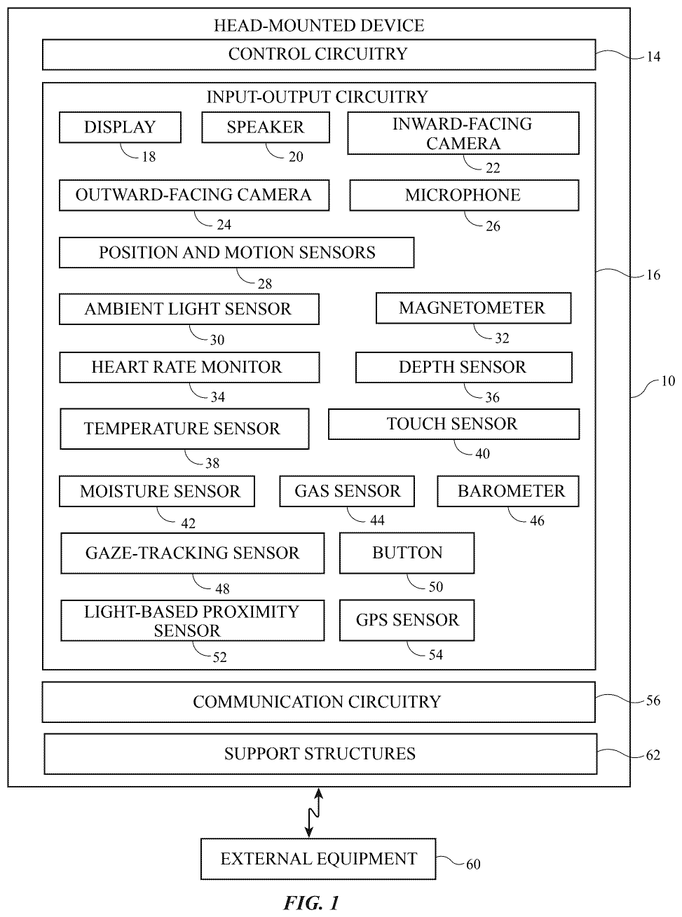

A schematic diagram of an illustrative electronic device is shown in FIG. 1. As shown in FIG. 1, electronic device 10 (sometimes referred to as head-mounted device 10, system 10, head-mounted display 10, etc.) may have control circuitry 14. In addition to being a head-mounted device, electronic device 10 may be other types of electronic devices such as a cellular telephone, laptop computer, speaker, computer monitor, electronic watch, tablet computer, etc. Control circuitry 14 may be configured to perform operations in head-mounted device 10 using hardware (e.g., dedicated hardware or circuitry), firmware and/or software. Software code for performing operations in head-mounted device 10 and other data is stored on non-transitory computer readable storage media (e.g., tangible computer readable storage media) in control circuitry 14. The software code may sometimes be referred to as software, data, program instructions, instructions, or code. The non-transitory computer readable storage media (sometimes referred to generally as memory) may include non-volatile memory such as non-volatile random-access memory (NVRAM), one or more hard drives (e.g., magnetic drives or solid-state drives), one or more removable flash drives or other removable media, or the like. Software stored on the non-transitory computer readable storage media may be executed on the processing circuitry of control circuitry 14. The processing circuitry may include application-specific integrated circuits with processing circuitry, one or more microprocessors, digital signal processors, graphics processing units, a central processing unit (CPU) or other processing circuitry.

Head-mounted device 10 may include input-output circuitry 16. Input-output circuitry 16 may be used to allow a user to provide head-mounted device 10 with user input. Input-output circuitry 16 may also be used to gather information on the environment in which head-mounted device 10 is operating. Output components in circuitry 16 may allow head-mounted device 10 to provide a user with output.

As shown in FIG. 1, input-output circuitry 16 may include a display such as display 18. Display 18 may be used to display images for a user of head-mounted device 10. Display 18 may be a transparent or translucent display so that a user may observe physical objects through the display while computer-generated content is overlaid on top of the physical objects by presenting computer-generated images on the display. A transparent or translucent display may be formed from a transparent or translucent pixel array (e.g., a transparent organic light-emitting diode display panel) or may be formed by a display device that provides images to a user through a transparent structure such as a beam splitter, holographic coupler, or other optical coupler (e.g., a display device such as a liquid crystal on silicon display). Alternatively, display 18 may be an opaque display that blocks light from physical objects when a user operates head-mounted device 10. In this type of arrangement, a pass-through camera may be used to display physical objects to the user. The pass-through camera may capture images of the physical environment and the physical environment images may be displayed on the display for viewing by the user. Additional computer-generated content (e.g., text, game-content, other visual content, etc.) may optionally be overlaid over the physical environment images to provide an extended reality environment for the user. When display 18 is opaque, the display may also optionally display entirely computer-generated content (e.g., without displaying images of the physical environment).

Display 18 may include one or more optical systems (e.g., lenses) (sometimes referred to as optical assemblies) that allow a viewer to view images on display(s) 18. A single display 18 may produce images for both eyes or a pair of displays 18 may be used to display images. In configurations with multiple displays (e.g., left and right eye displays), the focal length and positions of the lenses may be selected so that any gap present between the displays will not be visible to a user (e.g., so that the images of the left and right displays overlap or merge seamlessly). Display modules (sometimes referred to as display assemblies) that generate different images for the left and right eyes of the user may be referred to as stereoscopic displays. The stereoscopic displays may be capable of presenting two-dimensional content (e.g., a user notification with text) and three-dimensional content (e.g., a simulation of a physical object such as a cube).

The example of device 10 including a display is merely illustrative and display(s) 18 may be omitted from device 10 if desired. Device 10 may include an optical pass-through area where real-world content is viewable to the user either directly or through a tunable lens.

Input-output circuitry 16 may include various other input-output devices. For example, input-output circuitry 16 may include one or more speakers 20 that are configured to play audio and one or more microphones 26 that are configured to capture audio data from the user and/or from the physical environment around the user.

Input-output circuitry 16 may also include one or more cameras such as an inward-facing camera 22 (e.g., that face the user's face when the head-mounted device is mounted on the user's head) and an outward-facing camera 24 (that face the physical environment around the user when the head-mounted device is mounted on the user's head). Cameras 22 and 24 may capture visible light images, infrared images, or images of any other desired type. The cameras may be stereo cameras if desired. Inward-facing camera 22 may capture images that are used for gaze-detection operations, in one possible arrangement. Outward-facing camera 24 may capture pass-through video for head-mounted device 10.

As shown in FIG. 1, input-output circuitry 16 may include position and motion sensors 28 (e.g., compasses, gyroscopes, accelerometers, and/or other devices for monitoring the location, orientation, and movement of head-mounted device 10, satellite navigation system circuitry such as Global Positioning System circuitry for monitoring user location, etc.). Using sensors 28, for example, control circuitry 14 can monitor the current direction in which a user's head is oriented relative to the surrounding environment (e.g., a user's head pose). One or more of cameras 22 and 24 may also be considered part of position and motion sensors 28. The cameras may be used for face tracking (e.g., by capturing images of the user's jaw, mouth, etc. while the device is worn on the head of the user), body tracking (e.g., by capturing images of the user's torso, arms, hands, legs, etc. while the device is worn on the head of user), and/or for localization (e.g., using visual odometry, visual inertial odometry, or other simultaneous localization and mapping (SLAM) technique).

Input-output circuitry 16 may also include other sensors and input-output components if desired. As shown in FIG. 1, input-output circuitry 16 may include an ambient light sensor 30. The ambient light sensor may be used to measure ambient light levels around head-mounted device 10. The ambient light sensor may measure light at one or more wavelengths (e.g., different colors of visible light and/or infrared light).

Input-output circuitry 16 may include a magnetometer 32. The magnetometer may be used to measure the strength and/or direction of magnetic fields around head-mounted device 10.

Input-output circuitry 16 may include a heart rate monitor 34. The heart rate monitor may be used to measure the heart rate of a user wearing head-mounted device 10 using any desired techniques.

Input-output circuitry 16 may include a depth sensor 36. The depth sensor may be a pixelated depth sensor (e.g., that is configured to measure multiple depths across the physical environment) or a point sensor (that is configured to measure a single depth in the physical environment). The depth sensor (whether a pixelated depth sensor or a point sensor) may use phase detection (e.g., phase detection autofocus pixel(s)) or light detection and ranging (LIDAR) to measure depth. Any combination of depth sensors may be used to determine the depth of physical objects in the physical environment.

Input-output circuitry 16 may include a temperature sensor 38. The temperature sensor may be used to measure the temperature of a user of head-mounted device 10, the temperature of head-mounted device 10 itself, or an ambient temperature of the physical environment around head-mounted device 10.

Input-output circuitry 16 may include a touch sensor 40. The touch sensor may be, for example, a capacitive touch sensor that is configured to detect touch from a user of the head-mounted device.

Input-output circuitry 16 may include a moisture sensor 42. The moisture sensor may be used to detect the presence of moisture (e.g., water) on, in, or around the head-mounted device.

Input-output circuitry 16 may include a gas sensor 44. The gas sensor may be used to detect the presence of one or more gases (e.g., smoke, carbon monoxide, etc.) in or around the head-mounted device.

Input-output circuitry 16 may include a barometer 46. The barometer may be used to measure atmospheric pressure, which may be used to determine the elevation above sea level of the head-mounted device.

Input-output circuitry 16 may include a gaze-tracking sensor 48 (sometimes referred to as gaze-tracker 48 and gaze-tracking system 48). The gaze-tracking sensor 48 may include a camera and/or other gaze-tracking sensor components (e.g., light sources that emit beams of light so that reflections of the beams from a user's eyes may be detected) to monitor the user's eyes. Gaze-tracker 48 may face a user's eyes and may track a user's gaze. A camera in the gaze-tracking system may determine the location of a user's eyes (e.g., the centers of the user's pupils), may determine the direction in which the user's eyes are oriented (the direction of the user's gaze), may determine the user's pupil size (e.g., so that light modulation and/or other optical parameters and/or the amount of gradualness with which one or more of these parameters is spatially adjusted and/or the area in which one or more of these optical parameters is adjusted is adjusted based on the pupil size), may be used in monitoring the current focus of the lenses in the user's eyes (e.g., whether the user is focusing in the near field or far field, which may be used to assess whether a user is day dreaming or is thinking strategically or tactically), and/or other gaze information. Cameras in the gaze-tracking system may sometimes be referred to as inward-facing cameras, gaze-detection cameras, eye-tracking cameras, gaze-tracking cameras, or eye-monitoring cameras. If desired, other types of image sensors (e.g., infrared and/or visible light-emitting diodes and light detectors, etc.) may also be used in monitoring a user's gaze. The use of a gaze-detection camera in gaze-tracker 48 is merely illustrative.

Input-output circuitry 16 may include a button 50. The button may include a mechanical switch that detects a user press during operation of the head-mounted device.

Input-output circuitry 16 may include a light-based proximity sensor 52. The light-based proximity sensor may include a light source (e.g., an infrared light source) and an image sensor (e.g., an infrared image sensor) configured to detect reflections of the emitted light to determine proximity to nearby objects.

Input-output circuitry 16 may include a global positioning system (GPS) sensor 54. The GPS sensor may determine location information for the head-mounted device. The GPS sensor may include one or more antennas used to receive GPS signals. The GPS sensor may be considered a part of position and motion sensors 28.

Input-output circuitry 16 may include any other desired components (e.g., capacitive proximity sensors, other proximity sensors, strain gauges, pressure sensors, audio components, haptic output devices such as vibration motors, light-emitting diodes, other light sources, etc.).

Head-mounted device 10 may also include communication circuitry 56 to allow the head-mounted device to communicate with external equipment (e.g., a tethered computer, a portable device such as a handheld device or laptop computer, one or more external servers, or other electrical equipment). Communication circuitry 56 may be used for both wired and wireless communication with external equipment.

Communication circuitry 56 may include radio-frequency (RF) transceiver circuitry formed from one or more integrated circuits, power amplifier circuitry, low-noise input amplifiers, passive RF components, one or more antennas, transmission lines, and other circuitry for handling RF wireless signals. Wireless signals can also be sent using light (e.g., using infrared communications).

The radio-frequency transceiver circuitry in wireless communications circuitry 56 may handle wireless local area network (WLAN) communications bands such as the 2.4 GHz and 5 GHz Wi-Fi® (IEEE 802.11) bands, wireless personal area network (WPAN) communications bands such as the 2.4 GHz Bluetooth® communications band, cellular telephone communications bands such as a cellular low band (LB) (e.g., 600 to 960 MHz), a cellular low-midband (LMB) (e.g., 1400 to 1550 MHz), a cellular midband (MB) (e.g., from 1700 to 2200 MHz), a cellular high band (HB) (e.g., from 2300 to 2700 MHz), a cellular ultra-high band (UHB) (e.g., from 3300 to 5000 MHz, or other cellular communications bands between about 600 MHz and about 5000 MHz (e.g., 3G bands, 4G LTE bands, 5G New Radio Frequency Range 1 (FR1) bands below 10 GHz, etc.), a near-field communications (NFC) band (e.g., at 13.56 MHz), satellite navigations bands (e.g., an L1 global positioning system (GPS) band at 1575 MHz, an L5 GPS band at 1176 MHz, a Global Navigation Satellite System (GLONASS) band, a BeiDou Navigation Satellite System (BDS) band, etc.), ultra-wideband (UWB) communications band(s) supported by the IEEE 802.15.4 protocol and/or other UWB communications protocols (e.g., a first UWB communications band at 6.5 GHz and/or a second UWB communications band at 8.0 GHz), and/or any other desired communications bands.

The radio-frequency transceiver circuitry may include millimeter/centimeter wave transceiver circuitry that supports communications at frequencies between about 10 GHz and 300 GHz. For example, the millimeter/centimeter wave transceiver circuitry may support communications in Extremely High Frequency (EHF) or millimeter wave communications bands between about 30 GHz and 300 GHz and/or in centimeter wave communications bands between about 10 GHz and 30 GHz (sometimes referred to as Super High Frequency (SHF) bands). As examples, the millimeter/centimeter wave transceiver circuitry may support communications in an IEEE K communications band between about 18 GHz and 27 GHz, a Kₐ communications band between about 26.5 GHz and 40 GHz, a Kᵤ communications band between about 12 GHz and 18 GHz, a V communications band between about 40 GHz and 75 GHz, a W communications band between about 75 GHz and 110 GHz, or any other desired frequency band between approximately 10 GHz and 300 GHz. If desired, the millimeter/centimeter wave transceiver circuitry may support IEEE 802.1 lad communications at 60 GHz (e.g., WiGig or 60 GHz Wi-Fi bands around 57-61 GHz), and/or 5^{th} generation mobile networks or 5^{th} generation wireless systems (5G) New Radio (NR) Frequency Range 2 (FR2) communications bands between about 24 GHz and 90 GHz.

Antennas in wireless communications circuitry 56 may include antennas with resonating elements that are formed from loop antenna structures, patch antenna structures, inverted-F antenna structures, slot antenna structures, planar inverted-F antenna structures, helical antenna structures, dipole antenna structures, monopole antenna structures, hybrids of these designs, etc. Different types of antennas may be used for different bands and combinations of bands. For example, one type of antenna may be used in forming a local wireless link and another type of antenna may be used in forming a remote wireless link antenna.

During operation, head-mounted device 10 may use communication circuitry 56 to communicate with external equipment 60. External equipment 60 may include one or more external servers, an electronic device that is paired with head-mounted device 10 (such as a cellular telephone, a laptop computer, a speaker, a computer monitor, an electronic watch, a tablet computer, earbuds, etc.), a vehicle, an internet of things (IoT) device (e.g., remote control, light switch, doorbell, lock, smoke alarm, light, thermostat, oven, refrigerator, stove, grill, coffee maker, toaster, microwave, etc.), etc.

Electronic device 10 may have housing structures (e.g., housing walls, straps, etc.), as shown by illustrative support structures 62 of FIG. 1. In configurations in which electronic device 10 is a head-mounted device (e.g., a pair of glasses, goggles, a helmet, a hat, etc.), support structures 62 may include head-mounted support structures (e.g., a helmet housing, head straps, temples in a pair of eyeglasses, goggle housing structures, and/or other head-mounted structures). The head-mounted support structures may be configured to be worn on a head of a user during operation of device 10 and may support control circuitry 14, input-output circuitry 16, and/or communication circuitry 56.

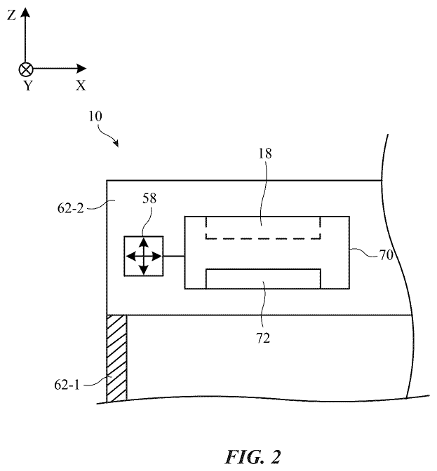

FIG. 2 is a top view of electronic device 10 in an illustrative configuration in which electronic device 10 is a head-mounted device. As shown in FIG. 2, electronic device 10 may include support structures (see, e.g., support structures 62 of FIG. 1) that are used in housing the components of device 10 and mounting device 10 onto a user's head. These support structures may include, for example, structures that form housing walls and other structures for main unit 62-2 (e.g., exterior housing walls, lens module structures, etc.) and eyeglass temples or other supplemental support structures such as structures 62-1 that help to hold main unit 62-2 on a user's face.

The electronic device may include optical modules such as optical module 70. The electronic device may include left and right optical modules that correspond respectively to a user's left eye and right eye. An optical module corresponding to the user's left eye is shown in FIG. 2.

Each optical module 70 includes a corresponding lens module 72 (sometimes referred to as lens stack-up 72, lens 72, or adjustable lens 72). Lens 72 may include one or more lens elements arranged along a common axis. Each lens element may have any desired shape and may be formed from any desired material (e.g., with any desired refractive index). The lens elements may have unique shapes and refractive indices that, in combination, focus light (e.g., from a display or from the physical environment) in a desired manner. Each lens element of lens module 72 may be formed from any desired material (e.g., glass, a polymer material such as polycarbonate or acrylic, a crystal such as sapphire, etc.).

Modules 70 may optionally be individually positioned relative to the user's eyes and relative to some of the housing wall structures of main unit 26-2 using positioning circuitry such as positioner 58. Positioner 58 may include stepper motors, piezoelectric actuators, motors, linear electromagnetic actuators, shape memory alloys (SMAs), and/or other electronic components for adjusting the position of displays, the optical modules 70, and/or lens modules 72. Positioners 58 may be controlled by control circuitry 14 during operation of device 10. For example, positioners 58 may be used to adjust the spacing between modules 70 (and therefore the lens-to-lens spacing between the left and right lenses of modules 70) to match the interpupillary distance IPD of a user's eyes. In another example, the lens module may include an adjustable lens element. The curvature of the adjustable lens element may be adjusted in real time by positioner(s) 58 to compensate for a user's eyesight and/or viewing conditions.

Each optical module may optionally include a display such as display 18 in FIG. 2. As previously mentioned, the displays may be omitted from device 10 if desired. In this type of arrangement, the device may still include one or more lens modules 72 (e.g., through which the user views the real world). In this type of arrangement, real-world content may be selectively focused for a user.

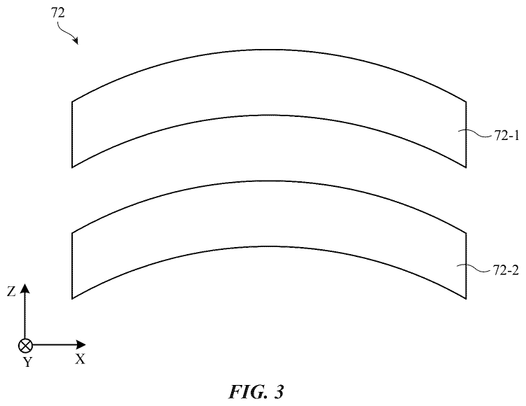

FIG. 3 is a cross-sectional side view of an illustrative lens module with multiple lens elements. As shown, lens module 72 includes a first lens element 72-1 and a second lens element 72-2. Each surface of the lens elements may have any desired curvature. For example, each surface may be a convex surface (e.g., a spherically convex surface, a cylindrically convex surface, or an aspherically convex surface), a concave surface (e.g., a spherically concave surface, a cylindrically concave surface, or an aspherically concave surface), a combination of convex and concave surfaces, or a freeform surface. A spherically curved surface (e.g., a spherically convex or spherically concave surface) may have a constant radius of curvature across the surface. In contrast, an aspherically curved surface (e.g., an aspheric concave surface or an aspheric convex surface) may have a varying radius of curvature across the surface. A cylindrical surface may only be curved about one axis instead of about multiple axes as with the spherical surface. In some cases, one of the lens surfaces may have an aspheric surface that changes from being convex (e.g., at the center) to concave (e.g., at the edges) at different positions on the surface. This type of surface may be referred to as an aspheric surface, a primarily convex (e.g., the majority of the surface is convex and/or the surface is convex at its center) aspheric surface, a freeform surface, and/or a primarily convex (e.g., the majority of the surface is convex and/or the surface is convex at its center) freeform surface. A freeform surface may include both convex and concave portions and/or curvatures defined by polynomial series and expansions. Alternatively, a freeform surface may have varying convex curvatures or varying concave curvatures (e.g., different portions with different radii of curvature, portions with curvature in one direction and different portions with curvature in two directions, etc.). Herein, a freeform surface that is primarily convex (e.g., the majority of the surface is convex and/or the surface is convex at its center) may sometimes still be referred to as a convex surface and a freeform surface that is primarily concave (e.g., the majority of the surface is concave and/or the surface is concave at its center) may sometimes still be referred to as a concave surface. In one example, shown in FIG. 3, lens element 72-1 has a convex surface that faces display 18 and an opposing concave surface. Lens element 72-2 has a convex surface that faces lens element 72-1 and an opposing concave surface.

One or both of lens elements 72-1 and 72-2 may be adjustable. In one example, lens element 72-1 is a non-adjustable lens element whereas lens element 72-2 is an adjustable lens element. The adjustable lens element 72-2 may be used to accommodate a user's eyeglass prescription, for example. The shape of lens element 72-2 may be adjusted if a user's eyeglass prescription changes (without needing to replace any of the other components within device 10). As another possible use case, a first user with a first eyeglass prescription (or no eyeglass prescription) may use device 10 with lens element 72-2 having a first shape and a second, different user with a second eyeglass prescription may use device 10 with lens element 72-2 having a second shape that is different than the first shape. Lens element 72-2 may have varying lens power and/or may provide varying amounts and orientations of astigmatism correction to provide prescription correction for the user.

The example of lens module 72 including two lens elements is merely illustrative. In general, lens module 72 may include any desired number of lens elements (e.g., one, two, three, four, more than four, etc.). Any subset or all of the lens elements may optionally be adjustable. Any of the adjustable lens elements in the lens module may optionally be fluid-filled adjustable lenses. Lens module 72 may also include any desired additional optical layers (e.g., partially reflective mirrors that reflect 50% of incident light, linear polarizers, retarders such as quarter wave plates, reflective polarizers, circular polarizers, reflective circular polarizers, etc.) to manipulate light that passes through lens module.

In one possible arrangement, lens element 72-1 may be a removable lens element. In other words, a user may be able to easily remove and replace lens element 72-1 within optical module 70. This may allow lens element 72-1 to be customizable. If lens element 72-1 is permanently affixed to the lens assembly, the lens power provided by lens element 72-1 cannot be easily changed. However, by making lens element 72-1 customizable, a user may select a lens element 72-1 that best suits their eyes and place the appropriate lens element 72-1 in the lens assembly. The lens element 72-1 may be used to accommodate a user's eyeglass prescription, for example. A user may replace lens element 72-1 with an updated lens element if their eyeglass prescription changes (without needing to replace any of the other components within electronic device 10). Lens element 72-1 may have varying lens power and/or may provide varying amount of astigmatism correction to provide prescription correction for the user. Lens element 72-1 may include one or more attachment structures that are configured to attach to corresponding attachment structures included in optical module 70, lens element 72-2, support structures 26, or another structure in electronic device 10.

In contrast with lens element 72-1, lens element 72-2 may not be a removable lens element. Lens element 72-2 may therefore sometimes be referred to as a permanent lens element, non-removable lens element, etc. The example of lens element 72-2 being a non-removable lens element is merely illustrative. In another possible arrangement, lens element 72-2 may also be a removable lens element (similar to lens element 72-1).

As previously mentioned, one or more of the adjustable lens elements may be a fluid-filled lens element. An example is described herein where lens element 72-2 from FIG. 3 is a fluid-filled lens element. When lens element 72-2 is a fluid-filled lens element, the lens element may include one or more components that define the surfaces of lens element 72-2. These elements may also be referred to as lens elements. In other words, adjustable lens element 72-2 (sometimes referred to as adjustable lens module 72-2, adjustable lens 72-2, tunable lens 72-2, etc.) may be formed by multiple respective lens elements.

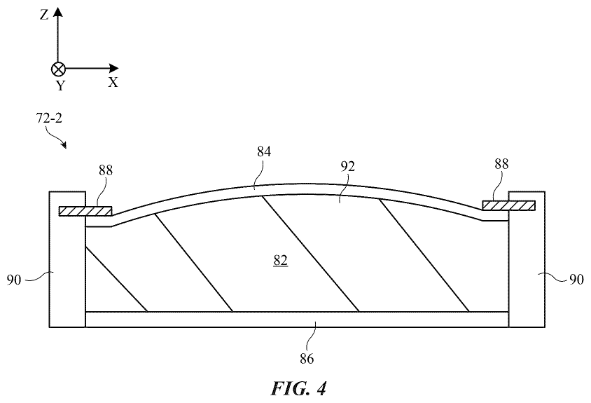

FIG. 4 is a cross-sectional side view of adjustable fluid-filled lens element 72-2. As shown, fluid-filled chamber 82 (sometimes referred to as chamber 82, fluid chamber 82, primary chamber 82, etc.) that includes fluid 92 is interposed between lens elements 84 and 86. Lens elements 84 and 86 may sometimes be referred to as part of chamber 82 or may sometimes be referred to as separate from chamber 82. Fluid 92 may be a liquid, gel, or gas with a pre-determined index of refraction (and may therefore sometimes be referred to as liquid 92, gel 92, or gas 92). The fluid may sometimes be referred to as an index-matching oil, an optical oil, an optical fluid, an index-matching material, an index-matching liquid, etc. Lens elements 84 and 86 may have the same index of refraction or may have different indices of refraction. Fluid 92 that fills chamber 82 between lens elements 84 and 86 may have an index of refraction that is the same as the index of refraction of lens element 84 but different from the index of refraction of lens element 86, may have an index of refraction that is the same as the index of refraction of lens element 86 but different from the index of refraction of lens element 84, may have an index of refraction that is the same as the index of refraction of lens element 84 and lens element 86, or may have an index of refraction that is different from the index of refraction of lens element 84 and lens element 86. Lens elements 84 and 86 may have a circular footprint, may have an elliptical footprint, may have or may have a footprint any another desired shape (e.g., an irregular footprint).

The amount of fluid 92 in chamber 82 may have a constant volume or an adjustable volume. If the amount of fluid is adjustable, the lens module may also include a fluid reservoir and a fluid controlling component (e.g., a pump, stepper motor, piezoelectric actuator, shape memory alloy (SMA), motor, linear electromagnetic actuator, and/or other electronic component that applies a force to the fluid in the fluid reservoir) for selectively transferring fluid between the fluid reservoir and the chamber.

Lens elements 84 and 86 may be transparent lens elements formed from any desired material (e.g., glass, a polymer material such as polycarbonate or acrylic, a crystal such as sapphire, etc.). Each one of lens elements 84 and 86 may be elastomeric, semi-rigid, or rigid. In one example, lens element 84 is an elastomeric lens element whereas lens element 86 is a rigid lens element.

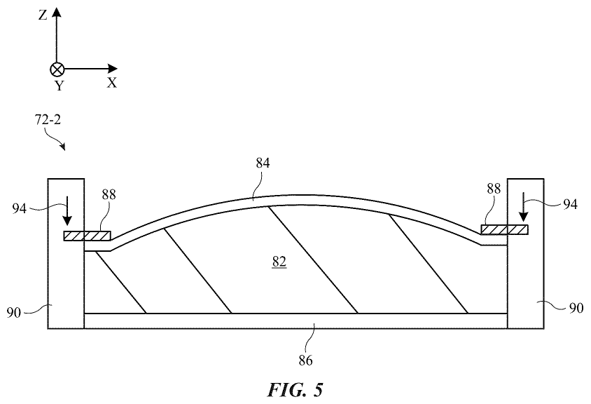

Elastomeric lens elements (e.g., lens element 84 in FIGS. 4 and 5) may be formed from a natural or synthetic polymer that has a low Young's modulus for high flexibility. For example the elastomeric membrane may be formed from a material having a Young's modulus of less than 1 GPa, less than 0.5 GPa, less than 0.1 GPa, etc.

Semi-rigid lens elements may be formed from a semi-rigid material that is stiff and solid, but not inflexible. A semi-rigid lens element may, for example, be formed from a thin layer of polymer or glass. Semi-rigid lens elements may be formed from a material having a Young's modulus that is greater than 1 Gpa, greater than 2 GPa, greater than 3 GPa, greater than 10 GPa, greater than 25 GPa, etc. Semi-rigid lens elements may be formed from polycarbonate, polyethylene terephthalate (PET), polymethylmethacrylate (PMMA), acrylic, glass, or any other desired material. The properties of semi-rigid lens elements may result in the lens element becoming rigid along a first axis when the lens element is curved along a second axis perpendicular to the first axis or, more generally, for the product of the curvature along its two principal axes of curvature to remain roughly constant as it flexes. This is in contrast to an elastomeric lens element, which remains flexible along a first axis even when the lens element is curved along a second axis perpendicular to the first axis. The properties of semi-rigid lens elements may allow the semi-rigid lens elements to form a cylindrical lens with tunable lens power and a tunable axis.

Rigid lens elements (e.g., lens element 86 in FIGS. 4 and 5) may be formed from glass, a polymer material such as polycarbonate or acrylic, a crystal such as sapphire, etc. In general, the rigid lens elements may not deform when pressure is applied to the lens elements within the lens module. In other words, the shape and position of the rigid lens elements may be fixed. Each surface of a rigid lens element may be planar, concave (e.g., spherically, aspherically, or cylindrically concave), or convex (e.g., spherically, aspherically, or cylindrically convex). Rigid lens elements may be formed from a material having a Young's modulus that is greater than greater than 25 GPa, greater than 30 GPa, greater than 40 GPa, greater than 50 GPa, etc.

In addition to lens elements 84 and 86 and fluid-filled chamber 82, lens module 72-2 also includes a lens shaping element 88. Lens shaping element 88 may be coupled to one or more actuators 90 (e.g., positioned around the circumference of the lens module). The lens shaping element 88 may also be coupled to lens element 84. Actuators 90 may be adjusted to position lens shaping element 88 (sometimes referred to as lens shaper 88, deformable lens shaper 88, lens shaping structure 88, lens shaping member 88, annular member 88, ring-shaped structure 88, etc.). The lens shaping element 88 in turn manipulates the positioning/shape of lens element 84. In this way, the curvature of the lens element 84 (and accordingly, the lens power of lens module 72-2) may be adjusted. An example of actuators 90 and lens shaper 88 being used to change the curvature of lens element 84 in FIG. 5. As shown, lens shaper 88 is moved in direction 94 by actuators 90. This results in lens element 84 having more curvature in FIG. 5 than in FIG. 4.

The example of tunable lens element 72-2 being a fluid-filled lens element is merely illustrative. In general, tunable lens element 72-2 may be any desired type of tunable lens element with adjustable optical power.

The shape (and corresponding optical power) of tunable lens element 72-2 may be adjusted in response to information from any of the components in input-output circuitry 16.

When a lens module includes a tunable lens, the overall optical quality of images viewed through the tunable lens may be sensitive to the optical power of the tunable lens, which may be dependent upon the position and curvature of the tunable lens. Head-mounted device 10 may therefore include one or more components to enable measurements of the real time position and curvature of an adjustable surface of the tunable lens. The measurements of the curvature and position of the adjustable surface may be used to determine the optical power of the tunable lens (and the entire lens module). There are several ways in which to measure the real time position and curvature of an adjustable surface of the tunable lens. The head-mounted device may include a camera formed separately from a display that measures the position of a grid of lights (glints) to determine the shape of the adjustable surface, may include photodiodes integrated into a display that measures the position of a grid of lights (glints) to determine the shape of the adjustable surface, may include a camera formed separately from a display that measures stray light from the lens module, may include a plurality of peripheral position sensors distributed around a perimeter of the adjustable surface of the tunable lens, and/or may include capacitive electrode layers for capacitive sensing that identifies the curvature and position of the adjustable surface of the tunable lens.

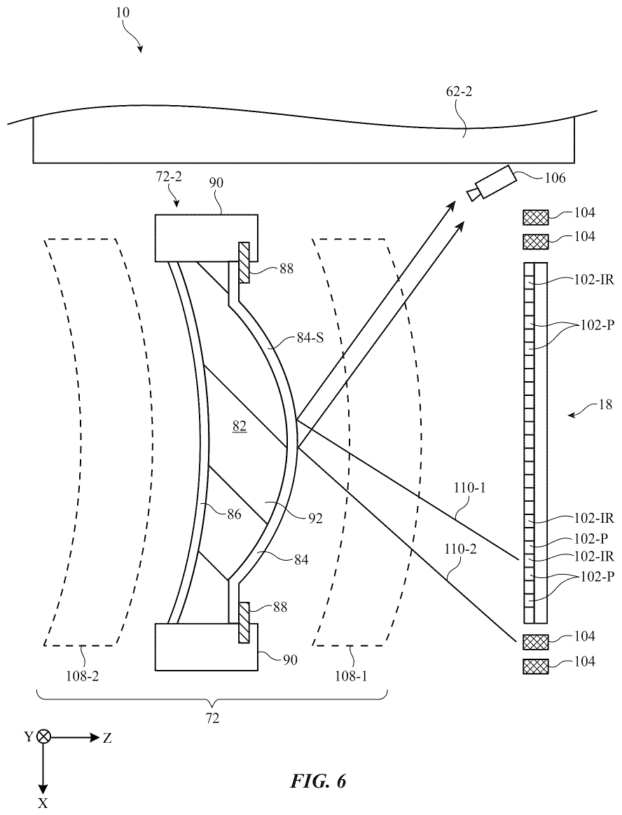

FIG. 6 is a side view of an illustrative head-mounted device with a camera formed separately from a display that measures the position of a grid of lights (glints) to determine the shape of the adjustable surface (and, correspondingly, the optical power of the tunable lens). As shown in FIG. 6, lens module 72 in head-mounted device 10 may include an adjustable lens 72-2 (similar to as shown and discussed in connection with FIGS. 4 and 5). Adjustable lens 72-2 has a lens element 84 that is manipulated to adjust the optical power of the adjustable lens. It may therefore be desirable to measure the curvature and position of surface 84-S of lens element 84 in order to determine the optical power being provided by adjustable lens 72-2 (and lens module 72 on the whole). FIG. 6 shows how lens module 72 may optionally include one or more additional non-adjustable lens elements 108-1 and 108-2 on either side of the adjustable lens element 72-2. Lens module 72 may, as one example, be a catadioptric lens module with one or more additional functional layers such as a partially reflective layer (e.g., between lens element 108-1 and display 18), a reflective polarizer (e.g., between lens elements 72-2 and 108-2), a quarter wave plate (e.g., between lens elements 72-2 and 108-1), and/or other desired functional layers.

To measure the curvature and position of surface 84-S of lens element 84, one or more infrared light sources may be included in head-mounted device 10. As shown in FIG. 6, one or more infrared light sources 104 may be distributed around a periphery of display 18. The infrared light sources are not formed on a substrate for display 18. The infrared light sources 104 may emit infrared light towards optical module 72. There may be at least 10 infrared light sources 104, at least 20 infrared light sources 104, at least 30 infrared light sources 104, at least 40 infrared light sources 104, at least 50 infrared light sources 104, etc.

Instead or in addition to infrared light sources 104, one or more infrared light sources may be integrated into display 18 itself. FIG. 6 shows an example where display has an array of pixels that includes visible light pixels 102-P and infrared light pixels 102-IR. The visible light pixels 102-P may include red pixels, green pixels, and blue pixels that emit light for an image that is perceived by a viewer of display 18. The infrared light pixels 102-IR may emit infrared light (e.g., light at a wavelength between 780 nanometers and 1000 microns). The infrared light pixels 102-IR may be interspersed amongst the visible light pixels 102-P in display 18. Display 18 may include less than 1,000 total infrared light pixels 102-IR, less than 100 total infrared light pixels 102-IR, less than 50 total infrared light pixels 102-IR, less than 40 total infrared light pixels 102-IR, less than 30 total infrared light pixels 102-IR, less than 20 total infrared light pixels 102-IR, etc. Each infrared light pixel 102-IR may be locally surrounded by visible light pixels 102-P. Display 18 may include at least 100 times more visible light pixels than infrared light pixels, at least 1,000 times more visible light pixels than infrared light pixels, at least 10,000 times more visible light pixels than infrared light pixels, etc.

FIG. 6 additionally shows how head-mounted device 10 may include an image sensor such as image sensor 106. The image sensor may be attached to support structure 62-2 or otherwise secured within the head-mounted device. Image sensor 106 may be an infrared image sensor, a visible light image sensor, or an image sensor capable of sensing both visible light and infrared light. Image sensor 106 may detect glints of infrared light that reflect off of surface 84-S (after being emitted by infrared light pixels 102-IR and/or infrared light sources 104). The pattern of the glints detected by image sensor 106 may be used to determine the position and curvature of surface 84-S.

FIG. 6 shows how infrared light from an infrared light pixel 102-IR may follow path 110-1 towards surface 84-S and reflect off surface 84-S towards camera 106. Similarly, infrared light from an infrared light source 104 may follow path 110-2 towards surface 84-S and reflect off surface 84-S towards camera 106. The point of reflection of infrared light off lens element 84 may be referred to as a glint.

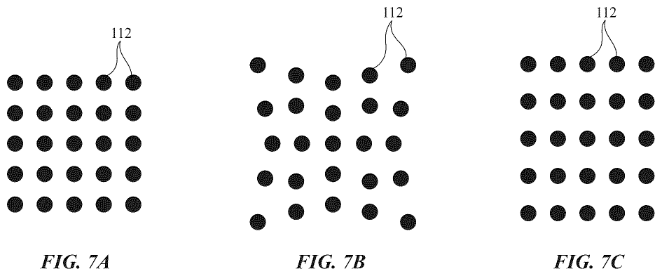

FIGS. 7A-7C show representative glint patterns that may be detected by camera 106. FIG. 7A shows a nominal grid of glints, FIG. 7B shows the grid of glints from FIG. 7A when surface 84-S has spherical curvature, and FIG. 7C shows the grid of glints from FIG. 7A when surface 84-S has cylindrical curvature. Each infrared light source 104 and 102-IR may have an associated glint. The infrared light sources may be arranged to create the incident glint pattern of FIG. 7A (e.g., a regular grid of rows and columns), as one example. As shown in FIG. 7B, spherical curvature in surface 84-S may cause the pattern of glints to be spread radially outward. As shown in FIG. 7C, cylindrical curvature in surface 84-S may cause the pattern of glints to have a first regular pitch in one direction and a second regular pitch that is greater than the first regular pitch in a second, orthogonal direction. It is noted that the patterns of FIGS. 7A-7C may be corrected for the perspective of image sensor 106.

Control circuitry 14 may include image processing circuitry that analyzes the images captured by image sensor 106. The image processing circuitry may identify the pattern of glints 112 associated with reflections from surface 84-S and determine the position and/or curvature of surface 84-S (and correspondingly the optical power of tunable lens 72-2) based on the detected pattern of glints. The image processing circuitry may optionally be integrated into image sensor 106.

FIG. 6 shows an example where infrared glints are used to determine the position and/or curvature of surface 84-S based on the detected pattern of glints. In this example, image sensor 106 may be sensitive to infrared light but not visible light (e.g., image sensor 106 is an infrared image sensor). In another possible example, infrared light sources 104 and infrared light pixels 102-IR may be omitted and image sensor 106 may sense visible light in order to measure the position and/or curvature of surface 84-S. In particular, image sensor 106 may be sensitive to visible light but not infrared light (e.g., image sensor 106 is a visible light image sensor). The visible light image sensor 106 may sense stray light that is emitted by display 18 and reflects towards the image sensor. There may be reflections off of different surfaces within lens module 72. The stray light reflections off of the different surfaces may be sensed by image sensor 106. The combination of different stray light reflections off of different surfaces in the optical module (e.g., first and second opposing surfaces of lens element 108-1, surface 84-S, a surface of lens element 86, etc.) may be used to determine the position and/or curvature of surface 84-S. Multiple visible light image sensors 106 may optionally be included to sense the stray light at different points to provide additional information used to determine the position and/or curvature of surface 84-S.

It should be noted that, in FIG. 6, infrared light sources 104 formed separately from display 18 may be omitted and all of the infrared light sources may be integrated into display 18. Alternatively, infrared light pixels 102-IR integrated into display 18 may be omitted and all of the infrared light sources may be formed separately from display 18.

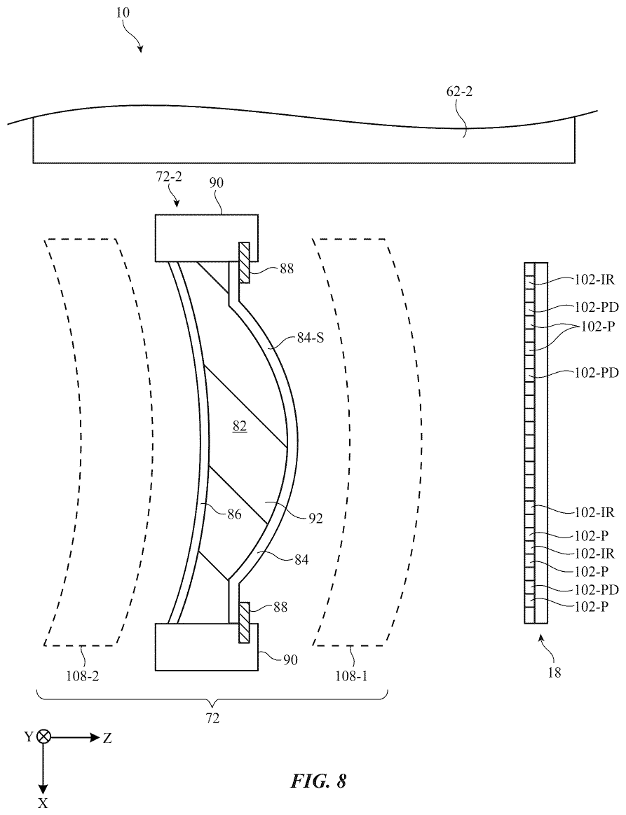

The example in FIG. 6 of image sensor 106 being formed separately from display 18 and attached to support structure 62-2 is merely illustrative. In another possible arrangement, shown in FIG. 8, photodiodes used to capture images of the glint pattern may be integrated into display 18. As shown in FIG. 8, display 18 may include visible light pixels 102-P and infrared light pixels 102-IR as shown and discussed in connection with FIG. 6. In addition, display 18 includes photodiodes 102-PD. The photodiodes 102-PD may be sensitive to infrared light (in embodiments where the photodiodes sense a glint pattern of infrared light from infrared light pixels 102-IR) or visible light (in embodiments where the photodiodes sense stray light from the lens module as previously discussed). In some embodiments, both photodiodes sensitive to visible light and photodiodes sensitive to infrared light may be included. Control circuitry may use the images captured by the photodiodes to determine the position and/or curvature of surface 84-S. The photodiodes 102-PD may collectively be referred to as an image sensor that is integrated into display 18.

Each photodiode may be locally surrounded by visible light pixels 102-P and/or infrared light pixels 102-IR. There may be any desired number of photodiodes integrated into the display (e.g., at least 50, at least 100, at least 1,000, at least 10,000, etc.). Photodiodes 102-PD, visible light pixels 102-P, and infrared light pixels 102-IR may share a common substrate.

The example in FIG. 8 of photodiodes 102-PD, visible light pixels 102-P, and infrared light pixels 102-IR all sharing a common substrate on display 18 is merely illustrative. In another possible arrangement, photodiodes 102-PD and visible light pixels 102-P may share a common substrate on display 18 and peripheral infrared light sources 104 may be used to generate a glint pattern.

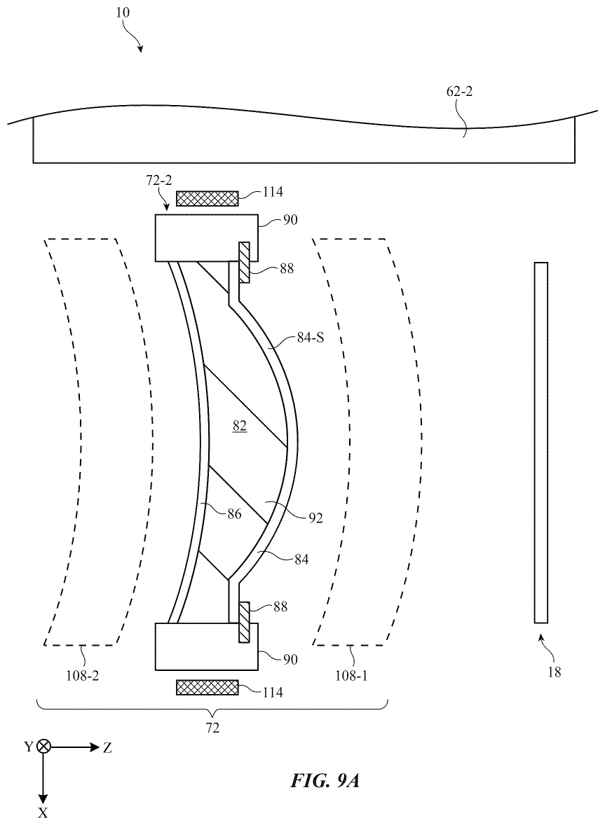

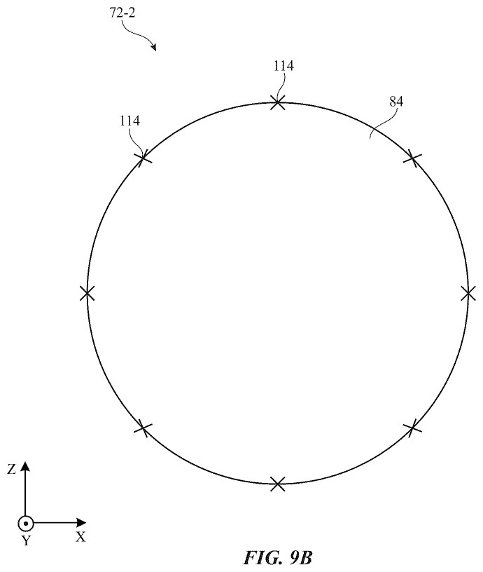

FIG. 9A is a side view of an illustrative head-mounted device with position sensors for determining the position and/or curvature of surface 84-S. As shown in FIG. 9A, optical module 72 may include one or more position sensors 114. Each position sensor 114 may measure the position of lens element 84 at a single point on the lens element. The position of lens element 84 may be measured relative to a fixed reference point such as lens element 86, lens element 108-1, or another desired fixed point. Position sensors 114 may include capacitive sensors, optical sensors, magnetic sensors, resistive sensors, and/or other desired type of sensors.

Measuring the position of lens element 84 at multiple peripheral points may provide information that identifies the curvature and position of surface 84-S of lens element 84. The position sensors may be distributed around the periphery of lens element 84. In general, more position sensors measuring more discrete points will improve the measurement of surface 84-S by position sensors 114. There may be at least 3 position sensors, at least 5 position sensors, at least 8 position sensors, at least 16 position sensors, at least 25 position sensors, etc.

FIG. 9B is a top view of an illustrative tunable lens 72-2 with eight position sensors 114 distributed around the circumference of lens element 84. There may be a 1:1 correlation between the number of position sensors 114 and the number of actuators 90 or there may be a different number of position sensors and actuators. The position sensors may be evenly distributed around the circumference or may be unevenly distributed around the circumference.

Calibration operations may optionally be performed using tunable lens 72-2 to determine the optical power of tunable lens 72-2 associated with a given set of measurements from position sensors 114. Later, during operation of head-mounted device 10, the real-time measurements from the position sensors may be used in combination with the calibration information to determine the optical power of tunable lens 72-2.

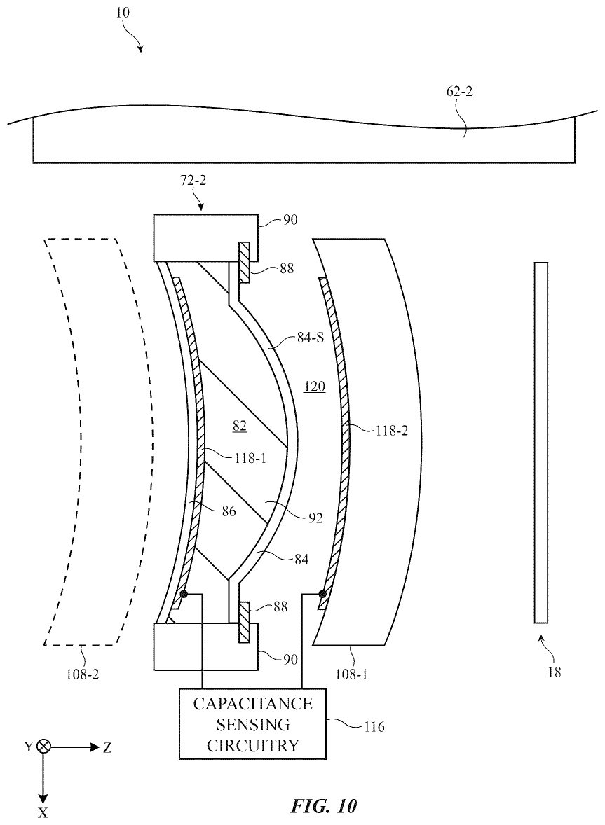

FIG. 10 is a side view of an illustrative head-mounted device with a capacitive sensor for determining the position and/or curvature of surface 84-S. As shown in FIG. 10, a first capacitive electrode layer 118-1 may be formed on lens element 86 (e.g., on a first side of fluid-filled chamber 82). A second capacitive electrode layer 118-2 may be formed on lens element 108-2 (e.g., on a second side of fluid-filled chamber 82). There is therefore both fluid-filled chamber 82 and an air gap 120 between capacitive electrode layers 118-1 and 118-2. Fluid 92 may have a higher dielectric constant than the air in air gap 120. Therefore, the capacitance between electrode layers 118-1 and 118-2 increases when fluid 92 displaces air between the electrode layers. By measuring the capacitance between electrode layers 118-1 and 118-2 (e.g., using capacitance sensing circuitry 116), the curvature and/or position of surface 84-S (and correspondingly the optical power of tunable lens 72-2) may be determined.

Each one of capacitive electrode layers 118-1 and 118-2 may include one or more patterned electrodes. The capacitive electrode layers 118-1 and 118-2 may be formed by a transparent conductive material (e.g., indium tin oxide) with a transparency that is greater than 80%, greater than 90%, greater than 95%, etc.

If desired, capacitive electrode layer 118-2 may be omitted and the capacitive sensing may rely on using fringing fields associated with capacitive electrode layer 118-1.

The foregoing is merely illustrative and various modifications can be made to the described embodiments. The foregoing embodiments may be implemented individually or in any combination.

What is claimed is:

1. An electronic device comprising:
a tunable lens;
at least one infrared light source configured to direct infrared light towards the tunable lens to generate a pattern of glints on an adjustable surface of the tunable lens;
an image sensor configured to capture an image of the pattern of glints; and
control circuitry configured to determine an optical power of the tunable lens based on the image of the pattern of glints.

2. The electronic device defined in claim 1, wherein the electronic device comprises a display that directs visible light towards the tunable lens.

3. The electronic device defined in claim 2, wherein the at least one infrared light source comprises a plurality of infrared light sources distributed around a periphery of the display.

4. The electronic device defined in claim 2, wherein the at least one infrared light source is formed separately from the display.

5. The electronic device defined in claim 2, wherein the at least one infrared light source is formed integrally with the display.

6. The electronic device defined in claim 2, wherein the display comprises visible light pixels and wherein the at least one infrared light source comprises infrared light pixels that are interspersed amongst the visible light pixels.

7. The electronic device defined in claim 2, wherein the display comprises photodiodes for the image sensor.

8. The electronic device defined in claim 2, wherein the image sensor is formed separately from the display.

9. An electronic device comprising:
a tunable lens having a lens element with adjustable curvature;
position sensors distributed around a periphery of the lens element, wherein each position sensor is configured to sense a position of a respective point of the periphery of the lens element; and
control circuitry configured to determine an optical power of the tunable lens based on the positions sensed by the position sensors.

10. The electronic device defined in claim 9, wherein the control circuitry is configured to determine the optical power of the tunable lens based on the positions sensed by the position sensors and stored calibration information.

11. The electronic device defined in claim 9, wherein the position sensors comprise capacitive sensors.

12. The electronic device defined in claim 9, wherein the position sensors comprise resistive sensors.

13. The electronic device defined in claim 9, wherein the position sensors comprise magnetic sensors.

14. The electronic device defined in claim 9, wherein the position sensors comprise optical sensors.

15. An electronic device comprising:
a tunable lens having a fluid-filled chamber defined by first and second lens elements, wherein the fluid-filled chamber has first and second opposing sides;
a first capacitive electrode layer that is formed on the first side of the fluid-filled chamber;
a second capacitive electrode layer that is formed on the second side of the fluid-filled chamber, wherein the fluid-filled chamber and an air gap are interposed between the first and second capacitive electrode layers; and
control circuitry configured to determine an optical power of the tunable lens based on a sensed capacitance between the first and second capacitive electrode layers.

16. The electronic device defined in claim 15, wherein the first and second capacitive electrode layers comprise a patterned transparent conductive material.

17. The electronic device defined in claim 16, wherein the patterned transparent conductive material comprises indium tin oxide.

18. The electronic device defined in claim 15, wherein the first lens element has adjustable curvature and wherein the first capacitive electrode layer is formed on the second lens element.

19. The electronic device defined in claim 18, further comprising:
an additional lens, wherein the air gap is interposed between the fluid-filled chamber and the additional lens and wherein second capacitive electrode layer is formed on the additional lens.

20. An electronic device comprising:
a lens module comprising a plurality of lens elements;
a display configured to emit light towards the lens module;
an image sensor configured to capture reflections of the light off multiple surfaces within the lens module; and
control circuitry configured to determine an optical power of the tunable lens based on the captured reflections of the light off the multiple surfaces within the lens module.
